(19) United States
(12) Patent Application Publication
(10) Pub. No.: US 2025/0049028 A1
(43) Pub. Date: Feb. 13, 2025

(54) BOTANICAL FORMULATIONS FOR PEST CONTROL

(71) Applicant: S. C. JOHNSON & SON, INC., Racine, WI (US)

(72) Inventors: Lina LONG, Sturtevant, WI (US); Hui Chao LI, Shanghai (CN); Hao QIAN, Racine, WI (US)

(21) Appl. No.: 18/232,744

(22) Filed: Aug. 10, 2023

(51) Int. Cl. A01N 37/08; A01M 1/20; A01M 29/12; A01N 25/06; A01N 31/06; A01P 7/04

(52) U.S. Cl. CPC A01N 37/08; A01M 1/2077; A01M 29/12; A01N 25/06; A01N 31/06; A01P 7/04

(57) ABSTRACT

A composition for pest control, the composition including at least one active component, at least one botanical solvent, and an antioxidant. Further, the botanical solvent comprises at least one renewable hydrocarbon.

### BACKGROUND

### 1. Technology Field

The present disclosure relates to a pest control composition and, more particularly, to a pest control composition that includes at least one renewable solvent.

### 2. Description of the Background

Pest control compositions are widely used to prevent insects from attacking humans, animals, and crops. One possible disadvantage of many insecticides and insect repellent compositions currently available is their use of petroleum-sourced solvents. Existing products may contain mineral oil, a petroleum product that can leave a residue on a treated surface, so that some of these products are not recommended for use on food contact surfaces. Additionally, petroleum products may, in some instances, impart an unpleasant odor to the product.

Sometimes fewer petroleum-based products are desirable because petrochemicals may be in limited, finite supply (i.e., not sustainable), may require energy-intensive processing, and are sometimes less environmentally friendly. Therefore, it is desirable to have an insecticidal or an insect repellent composition that includes renewable components and does not rely on petroleum-based ingredients.

### SUMMARY

In one aspect, a composition for pest control is provided. In this embodiment, the pest control composition includes least one active component, at least one botanical solvent, and an antioxidant, where the botanical solvent includes at least one renewable hydrocarbon.

In further embodiments, the active component is between about 0.01 wt. % and about 20 wt. % of at least one active component selected from the group consisting essentially of prallethrin, meperfluthrin, metofluthrin, transfluthrin, dimefluthrin, natural pyrethrin extract, p-menthane-3,8-diol, and combinations thereof. Further, the botanical solvent comprises at least one C₁₅-C₁₈ branched alkane, and all weight percentages are percent by weight of the total composition. In other embodiments, the composition includes between about 0.01 wt. % and about 2 wt. % of an antioxidant.

In additional embodiments, the composition includes between about 0.01 wt. % and about 20 wt. % of at least one active component selected from the group consisting essentially of prallethrin, meperfluthrin, metofluthrin, transfluthrin, dimefluthrin, natural pyrethrin extract, p-menthane-3,8-diol, and combinations thereof, between about 0.1 wt. % to about 99 wt. % of a first botanical solvent, and between about 0.1 wt. % to about 99 wt. % of a second botanical solvent. Further, the first botanical solvent includes a C₁₅-C₁₈ branched alkane and the second botanical solvent includes a C₁₇-C₁₈ branched alkane, and each of the first and second botanical solvents contain less than about 0.005 wt. % aromatic hydrocarbon. In some embodiments, the composition includes greater than 90 wt. % of one of the first botanical solvent or the second botanical solvent. In still further embodiments, the active component is present at between about 0.1 wt. % to about 2.0 wt. %.

In further aspects, the composition includes between about 0.01 wt. % to about 2 wt. % of the antioxidant. In some aspects, the antioxidant is selected from the group consisting essentially of 2,6-di-tert-butyl-4-methylphenol (BHT), 3-tert-butyl-4-hydroxyanisole (BHA), 2,2′-methylene-bis(4-ethyl-6-tert-butylphenol), 2,2′-methylene-bis-(4-methyl-6-tert-butylphenol), 4,4′-butylidene-bis(5-methyl-6-tert-butylphenol), 4,4′-methylene-bis(2-methyl-6-tert-butylphenol), 4,4′-thio-bis(3-methyl-6-tert-butylphenol), 4,4′-methylene-bis(2,6-di-tertbutylphenol), stearyl-P(3,5-di-tert-butyl-4-hydroxyphenol)-propionate, 1,3,5-trimethyl-2,4-6-tris(3,5-di-tert-butyl-4-hydroxybenzylbenzene), 1,1,3-tris(2-methyl-4-hydroxy-5-tert-butyl)-butane, tetrakis [methylene(3,5-di-tert-butyl-4-hydroxycinnimate)]methane, dilauryl thiodipropionate, distearyl thiodipropionate, and any combinations thereof. The composition may also include a fragrance. In some aspects, the fragrance is present in about 0.01 wt. % to about 8 wt. %.

In particular embodiments, the composition may also be used in combination with a heating device or apparatus that includes a heating element adjacent to a first end of a wick and a reservoir enclosing a second end of the wick, in which the composition may be contained. In this embodiment, the composition may be in contact with the second end of the wick, and upon application of an electric current to the heating element, the composition may be vaporized from the wick.

Other aspects of the present disclosure provide an apparatus for pest control. Here, the apparatus includes an electric device with a wick having a first end and a second end. Further, the apparatus also includes a composition in contact with the second end of the wick. In this embodiment, the composition includes at least one active component, at least one botanical solvent with at least one renewable hydrocarbon, and an antioxidant.

In other embodiments, the composition includes a propellant, where the propellant may include or is selected from the group consisting essentially of compressed gas propellants, liquified gas propellants, saturated hydrocarbons, mixtures of liquified and compressed gas, methane, ethane, propane, n-butane, isobutane, isobutene, pentane, isopentane, dimethyl ether, 1,1-difluoroethane, 1,1,1,2-tetrafluoroethane, carbon dioxide, nitrogen, air, and any combinations thereof. In still further embodiments, the botanical solvent is at least about 95 wt. % renewable hydrocarbon.

In further embodiments, the composition may include between about 0.01 wt. % to about 20 wt. % of at least one active component selected from the group consisting essentially of prallethrin, meperfluthrin, metofluthrin, transfluthrin, dimefluthrin, pyrethrin extract, p-menthane-3,8-diol, and combinations thereof, and between about 40 wt. % to about 99 wt. % of the botanical solvent. In another aspect, the composition may include between about 0.1 wt. % to about 2.0 wt. % of at least one active component selected from the group consisting essentially of prallethrin, meperfluthrin, metofluthrin, transfluthrin, dimefluthrin, pyrethrin extract, p-menthane-3,8-diol, and combinations thereof, between about 1.0 wt. % to about 99 wt. % of a first botanical solvent, and about 1.0 wt. % to about 99 wt. % of a second botanical solvent, where the first botanical solvent and the second botanical solvent include renewable hydrocarbons. Further, the composition may also include a fragrance. The fragrance may be present in about 0.01 wt. % to about 8 wt. %.

### DETAILED DESCRIPTION

Based on consumer demand, there is a need for effective pest control compositions where most of the ingredients are from renewable, natural sources. These compositions provide consumer satisfaction regarding sustainability as well as improved aesthetics (e.g., scent) and safer perception without sacrificing efficacy.

The term “renewable” as used herein refers to a material derived from readily replenished sources. Renewable resources can include cultivated, living organisms, such as farmed plants. Renewable materials can be derived from plants, algae, bacteria, biomass, or natural waste products. Because they are derived from modern living organisms, renewable materials contain renewable carbon that can be measured according to the “Assessment of the Biobased Content of Materials” method, ASTM D6866-16. In particular embodiments, the term “renewable” may refer to solvents created from plant-based sources, such as solvents produced from 85%, 90%, 95%, or 100% plant-based sources. Further, in particular embodiments, renewable may refer to solvents created from plant-based sources, excluding solvents created from palm plants. In other embodiments, renewable may refer to solvents that are obtained from 100% certified vegetable origin feedstocks excluding palm. In contrast to renewable materials, petrochemicals and materials derived from fossil fuels and/or other geological sources (e.g., coal, natural gas) do not contain renewable carbon, i.e., these petrochemicals exist in a finite supply and cannot be easily replenished or regrown.

A material may be partially renewable (less than 100% renewable carbon content, from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable material may be blended with a geologically derived feedstock, resulting in a material with a renewable component and a geologically derived component.

The term “about” or “approx.”, as used herein, refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values +/−5% of a specified value.

The term “weight percent”, “wt. %”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Embodiments of the disclosure can be used to control parasites. The term “parasite” includes endoparasites and ectoparasites. Endoparasites include, but are not limited to, protozoa, including intestinal protozoa, tissue protozoa, and blood protozoa. Ectoparasites include, but are not limited to, roundworms, worms, ticks, fleas, lice, and other organisms found on an external orifice or found on or in a skin surface.

Further, for purposes of this application, the term “pest control” shall refer to having a repellant effect, a pesticidal effect, or both. “Repellant effect” is an effect wherein more insects are repelled away from a host or area that has been treated with the composition than a control host or area that has not been treated with the composition. Similarly, the term “repelling” or “repel” refers to the ability of the compositions described herein to cause a pest or insect to deviate away from or avoid a surface, object, or insect breeding site treated with the composition. In some embodiments, as will be shown in the present disclosure, a repellant effect is an effect wherein at least about 75% of insects are repelled away from a host or area that has been treated with the composition. In some embodiments, however, a repellant effect is an effect wherein at least about 90% of insects are repelled away from a host or area that has been treated with the composition. In addition, “pesticidal effect” is an effect wherein treatment with a composition causes at least about 1% insect mortality. In this regard, an LC1 to LC100 (lethal concentration) or an LD1 to LD100 (lethal dose) of a composition will cause a pesticidal effect. In some embodiments, the pesticidal effect is an effect wherein treatment with a composition causes at least about 5% of the exposed insects to die. In some embodiments, the target pest is a non-insect, such as a parasite.

As used herein, the term “knocking down” or “knockdown” refers to the ability of the composition described herein to render an insect immobile for a predetermined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

As used herein, the term “killing” or “kill” refers to the ability of at least one active ingredient in a composition to render an insect dead.

In the pest control field, it is known that consumers desire a product that is environmentally friendly and has naturally sourced components without sacrificing efficacy. Therefore, it is important to develop an insecticidal composition and an insect repellent composition that includes renewable or plant-based ingredients while maintaining the insect killing/repelling efficacies.

The insecticidal composition according to an embodiment of the present disclosure is a composition comprising (i) at least one active component (e.g., prallethrin, metofluthrin, meperfluthrin, transfluthrin, pyrethrin extract, p-menthane-3,8-diol (PMD), and combinations thereof), (ii) at least one botanical solvent, (iii) optionally an antioxidant, (iv) optionally a fragrance. In an embodiment, the composition optionally comprises a fragrance. The compositions described herein present a novel combination of active ingredients with botanical solvents, optionally an antioxidant, and optionally a fragrance, resulting in an improved insecticidal composition that offers consumers a sustainable, effective product.

In certain embodiments, the insecticidal compositions include an active component and an inert or relatively inert component. In some embodiments, the active component includes pyrethrins, pyrethroids, or p-menthane-3,8-diol (PMD). The compositions of the present disclosure may also include one or more inert or relatively inert components. In certain embodiments, for example, the compositions of the present disclosure may include a botanical solvent, an antioxidant, and/or a propellant.

### Active Components

In some embodiments, the active component of the pest control compositions of the present disclosure can include one or more pyrethrins or pyrethroids. In specific embodiments, the active component of the pest control composition includes one or more of prallethrin, metofluthrin, meperfluthrin, transfluthrin, pyrethrin extract, p-menthane-3,8-diol (PMD), and combinations thereof.

### Pyrethroids

The active component is an insecticide and/or insect repellent, a natural repellent such as citronella oil, a natural pyrethrin, a pyrethrum extract, or a synthetic pyrethroid. Suitable synthetic pyrethroids are acrinathrin, allethrin as D-allethrin, Pynamin®, benfluthrin, bifenthrin, bioallethrin as Pynamin Forte®, S-bioallethrin, esbiothrin, esbiol, bisoresmethrin, cycloprothrin, cyfluthrin, beta-cyfluthrin, cyhalothrin, lambda-cyhalothrin, cypermethrin, alpha-cypermethrin, beta-cypermethrin, cyphenothrin, deltamethrin, empenthrin, esfenvalerate, fenpropathrin, fenvalerate, flucythrinate, taufluvalinate, kadethrin, permethrin, phenothrin, prallethrin as Etoc®, resmethrin, tefluthrin, tetramethrin, tralomethrin, metofluthrin, transfluthrin, dimefluthrin, and/or combinations thereof. Other insecticides, such as those described in U.S. Pat. No. 4,439,415, may also be employed.

### Prallethrin

Prallethrin (CAS No. 23031-36-9) is a member of the pyrethroid class of insecticides and has the IUPAC name 2-methyl-4-oxo-3-prop-2-yn-1-ylcyclopent-2-en-1-yl-2,2-dimethyl-3-(2-methylprop-1-en-1-yl)cyclopropanecarboxylate.

### Metofluthrin

Metofluthrin (CAS No. 240494-70-6) is a member of the pyrethroid class of insecticides and has the IUPAC name 2,3,5,6-Tetrafluoro-4-(methoxymethyl)benzyl 2,2-dimethyl-3-(prop-1-en-1-yl)cyclopropanecarboxylate.

### Meperfluthrin

Meperfluthrin (CAS No. 915288-13-0) is a member of the pyrethroid class of insecticides and has the IUPAC name [2,3,5,6-tetrafluoro-4-(methoxymethyl)phenyl]methyl (1R,3S)-3-(2,2-dichloroethenyl)-2,2-dimethylcyclopropane-1-carboxylate.

### Transfluthrin

Transfluthrin (CAS No. 118712-89-3) is a member of the pyrethroid class of insecticides and has the IUPAC name (2,3,5,6-tetrafluorophenyl)methyl (1R,3S)-3-(2,2-dichloroethenyl)-2,2-dimethylcyclopropane-1-carboxylate.

### Dimefluthrin

Dimefluthrin (CAS No. 271241-14-6) is a member of the pyrethroid class of insecticides and has the IUPAC name 2,3,5,6-Tetrafluoro-4-(methoxymethyl) benzyl (1RS,3RS; 1RS,3SR)-2,2-dimethyl-3-(2-methylprop-1-enyl)cyclopropanecarboxylate.

### Pyrethrin Extract

Pyrethrin extract is a chrysanthemum flower extract that can be used as an insecticide. Pyrethrum is the total crude extract form obtained from flowers of a chrysanthemum plant, for example Chrysanthemum cinerarijfolium. Pyrethrins are the 6 molecules found in pyrethrin extract that possess insecticidal properties: pyrethrin I, pyrethrin II, jasmolin I, jasmolin II, cinerin I, and cinerin II.

p-Menthane-3,8-diol (PMD)

p-Menthane-3,8-diol (PMD) (CAS No. 42822-86-6) is found in small quantities in the essential oil from the leaves of Corymbia citriodora (Eucalyptus citriodora oil). In some embodiments, Citriodiol® (Citrefine International, LTD) (CAS no. 1245629-80-4) is used to provide PMD. Citriodiol® contains at least 64% (and more typically about 72%) of the naturally occurring constituent PMD (p-menthane-3,8-diol) whereas Citronella oil contains only trace quantities of PMD. Citriodiol® also contains a small amount of isopulegol and PMD-citronellal acetal, all of which are found in the essential oil.

In particular embodiments, the active component is at least one insecticide or insect repellent selected from the group comprising prallethrin, metofluthrin, meperfluthrin, transfluthrin, dimefluthrin, pyrethrin extract, PMD (as Citriodiol®), and combinations thereof. In particular embodiments, the active component is at least one insecticide or insect repellent selected from the group consisting of prallethrin, metofluthrin, meperfluthrin, transfluthrin, pyrethrin extract, PMD/Citriodiol®, and combinations thereof. In an embodiment, transfluthrin is the active component insecticide. In another embodiment, metofluthrin is the insecticide. In another particular embodiment, meperfluthrin is the active component. In another particular embodiment, dimefluthrin is the active component. In still another embodiment, prallethrin is the active component. In another embodiment, pyrethrin extract is the active component. In yet another embodiment, PMD/Citriodiol® is the active component.

The total amount of the active component (e.g., the total amount of insecticide or insect repellant in the composition) may be from about 0.01 wt. %, or from about 0.05 wt. %, or from about 0.1 wt. %, or from about 0.2 wt. %, or from about 0.3 wt. %, or from about 0.4 wt. %, or from about 0.5 wt. %, or from about 0.6 wt. %, or from about 0.7 wt. %, or from about 0.8 wt. % or from about 0.9 wt. %, or from about 1 wt. %, or from about 1.1 wt. %, or from about 1.2 wt. % or from about 1.3 wt. %, or from about 1.4 wt. %, or from about 1.5 wt. %, or from about 1.6 wt. %, or from about 1.7 wt. %, or from about 1.8 wt. %, or from about 1.9 wt. %, or from about 2 wt. %, or from about 2.3 wt. %, or from about 5 wt. %, or from about 6 wt. %, or from about 7 wt. %, or from about 8 wt. %, or from about 9 wt. %, or from about 10 wt. %, and to about 20 wt. %, or to about 15 wt. %, or to about 12 wt. %, or to about 10 wt. %, or to about 8 wt. %, or to about 6 wt. %, or to about 4 wt. %, or to about 3 wt. %, or to about 2.5 wt. %, or to about 2 wt. %, or to about 1.5 wt. % or to about 1.4 wt. %, or to about 1.3 wt. %, or to about 1.2 wt. %, or to about 1.1 wt. %, or to about 1 wt. %, or to about 0.9 wt. %, or to about 0.8 wt. %, or to about 0.7 wt. %, or to about 0.6 wt. %, or to about 0.5 wt. %, or to about 0.4 wt. %, or to about 0.3 wt. %.

In an embodiment, the total amount active component is present in an amount from about 0.01 wt. % to about 20 wt. %, 0.1 wt. % to about 15 wt. %, or from about 0.2 wt. % to about 6 wt. %, or from about 0.3 wt. % to about 4 wt. %, or from about 0.4 wt. % to about 1.3 wt. %, wherein all weight percentages are percent by weight of the total composition. In an embodiment, the total amount active component is present in an amount from about 0.4 wt. % to about 2.0 wt. %, wherein all weight percentages are percent by weight of the total composition. In an embodiment, the total amount active component is present in an amount of about 1.3 wt. % based on the total weight of the total composition. In an embodiment, the total amount active component is present in an amount of about 0.9 wt. % based on the total weight of the total composition. In an embodiment, the total amount active component is present in an amount of about 0.4 wt. % based on the total weight of the total composition.

While specific wt. % values chosen for this embodiment are recited, it is to be understood that, within the scope of the disclosure, the wt. % values of the active component may vary to suit different applications.

Other Active Components. The compositions of the present disclosure, and the active component thereof, may also include other active components other than pyrethrins and pyrethroids. For example, the composition may include one or more active ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25(f).

### Other Components

The compositions of the present disclosure may also include one or more of what may be considered as inert or relatively inert components. In certain embodiments, for example, the compositions of the present disclosure may include a botanical solvent, an antioxidant, and/or a fragrance, and/or a propellant, or any combination thereof.

Botanical Solvent. The formulation or composition of the present disclosure may include a botanical solvent. The botanical solvent is a renewable solvent, i.e., it is natural, plant-based, and derived from a renewable resource. The botanical solvent serves to dissolve certain components, to enhance functionality of the components, and/or for textural and sensorial attributes. The botanical solvent may be an inert or fluid material, which can be organic and of natural origin. The active components can be mixed or formulated with the botanical solvent to facilitate application of the active components to the host, area, or other object to be treated. The botanical solvent may facilitate storage, transport, and/or handling of the formulation.

In certain embodiments the botanical solvent includes renewable isoparaffins. In some embodiments, the botanical solvent can be ISANE®58, ISANE®78, or combinations thereof. ISANE®58 and ISANE® 78 are BioLife solvents (TotalEnergies, 2 place Jean Millier 92078 Paris la Défense cedex, France) that are biomass-based renewable isoalkanes. These renewable solvents are obtained from 100% certified plant-based vegetable origin feedstocks and come from hydrogenated vegetable oils. Unlike some non-renewable petroleum-based solvents, ISANE® 58 and ISANE® 78 solvents contain less than 50 ppm of aromatic compounds. ISANE® 58 includes C₁₅-C₁₈ n-alkanes and is a combination of mainly CₙH₂ₙ₊₂ Structures, mainly having a carbon number range from C₁₅ to C₁₈. More specifically, ISANE® 58 includes C₁₅H₃₂, C₁₆H₃₄, C₁₇H₃₆ and C₁₈H₃₈. ISANE® 78 includes C₁₇-C₁₈ n-alkanes and isoalkanes and is a combination of mainly CₙH₂ₙ₊₂ structures comprised mainly with a carbon number range from C₁₇ to C₁₈. ISANE® 78 contains <0.005% aromatics.

Physical properties and compositional aspects of ISANE® 58 and ISANE® 78 are shown in Table 1. Notably, these botanical solvents have a low aromatic content (50 ppm), a low benzene content (<1 ppm), and low sulfur content (<1 ppm).

TABLE 1
Identifiers, physical properties, and composition of
ISANE ® 58 and ISANE ® 78, and the method by
which the properties were determined.

| | ISANE ® | ISANE ® | |
|---|---|---|---|
| | 58 | 78 | methods |
| EC number | 942-445-1 | 942-446-7 | NA |
| carbon chain length HSPA | C₁₅-C₁₈ | C₁₇-C₁₈ | NA |
| density at 15° C. (kg/m²) | 780 | 787 | ISO 12185 |
| Saybolt color (color units) | 30 | 30 | ASTM D156 |
| Boiling range: -initial point (° C.) | 259 | 290 | ASTM D86 |
| -final point | 289 | 320 | |
| Flash point: -PM (° C.) | 126 | 151 | ASTM D93 |
| Aromatic content (ppm) | ≤50 | ≤50 | UV internal |
| | | | method |
| Benzene content (ppm) | <1 | <1 | AST D6229 |
| Sulfur content (ppm) | <1 | <1 | ASTM D5453 |
| Aniline point (° C.) | 95 | 99 | ASTM D611 |
| Kauri butanol (KB unit) | 21 | 19 | ASTM D1133 |
| Evaporation rate (Ether = 1) | >120 | >120 | DIN 53170 |
| Vapor pressure at 20° C. (kPa) | 0.001 | 0.001 | calculated |
| Surface tension (mN/m) | 22.9 | 37.7 | EN 14370 |
| Viscosity: -at 40° C. (mm²/s) | 3 | 3.9 | ASTM D 445 |
| Pour point (° C.) | −60 | −45 | ASTM D97 |

In certain embodiments, the composition includes at least one botanical solvent. In certain embodiments, the composition includes one botanical solvent. In certain embodiments, the composition includes a mixture of two botanical solvents. In certain embodiments, the composition includes a mixture of at least three botanical solvents. The combined botanical solvent portion of the composition makes up greater than about 1 wt. %, greater than about 10 wt. %, greater than about 20 wt. %, greater than about 30 wt. %, greater than about 40 wt. %, greater than about 50 wt. %, greater than about 60 wt. %, greater than about 70 wt. %, greater than about 80 wt. %, greater than about 90 wt. %, or greater than about 95 wt. %.

In certain embodiments, the composition includes about 40 wt. % to about 99 wt. % of the botanical solvent, about 60 wt. % to about 99 wt. % of the botanical solvent, about 65 wt. % to about 95 wt. % of the botanical solvent, about 65 wt. % to about 85 wt. %, or greater than about 95% by weight of the botanical solvent, based on the total weight of the composition. In certain embodiments, greater than about 95 wt. % of the solvent component of the composition is from a renewable source, based on the total weight of the composition.

While specific values chosen for this embodiment are recited, it is to be understood that, within the scope of the disclosure, the concentration of solvent may vary to suit different applications. The concentration ranges of solvent will vary based on the additional components of the insecticidal composition, including, but not limited to, the active components and the antioxidant.

In certain embodiments, the composition for pest control is substantially free of aromatic hydrocarbons. In certain embodiments, the composition for pest control is free of aromatic hydrocarbons. In certain embodiments, the solvent consists essentially of a renewable hydrocarbon solvent. In certain embodiments, the solvent consists of a renewable hydrocarbon solvent.

Antioxidant. In certain embodiments, the composition includes at least one antioxidant. In certain embodiments, the antioxidant may be selected from the group comprising 2,6-di-tert-butyl-4-methylphenol (BHT), 3-tert-butyl-4-hydroxyanisole (BHA), 2,2′-methylene-bis(4-ethyl-6-tert-butylphenol), 2,2′-methylene-bis-(4-methyl-6-tert-butylphenol), 4,4′-butylidene-bis(5-methyl-6-tert-butylphenol), 4,4′-methylene-bis(2-methyl-6-tert-butylphenol), 4,4′-thio-bis(3-methyl-6-tert-butylphenol), 4,4′-methylene-bis(2,6-di-tertbutylphenol), stearyl-P(3,5-di-tert-butyl-4-hydroxyphenol)-propionate, 1,3,5-trimethyl-2,4-6-tris(3,5-di-tert-butyl-4-hydroxybenzylbenzene), 1,1,3-tris(2-methyl-4-hydroxy-5-tert-butyl)-butane, tetrakis [methylene(3,5-di-tert-butyl-4-hydroxycinnimate)]methane, dilauryl thiodipropionate, and distearyl thiodipropionate. In certain embodiments, the antioxidant can be selected from the group consisting of 2,6-di-tert-butyl-4-methylphenol (BHT), 3-tert-butyl-4-hydroxyanisole (BHA), 2,2′-methylene-bis(4-ethyl-6-tert-butylphenol), 2,2′-methylene-bis-(4-methyl-6-tert-butylphenol), 4,4′-butylidene-bis(5-methyl-6-tert-butylphenol), 4,4′-methylene-bis(2-methyl-6-tert-butylphenol), 4,4′-thio-bis(3-methyl-6-tert-butylphenol), 4,4′-methylene-bis(2,6-di-tertbutylphenol), stearyl-P(3,5-di-tert-butyl-4-hydroxyphenol)-propionate, 1,3,5-trimethyl-2,4-6-tris(3,5-di-tert-butyl-4-hydroxybenzylbenzene), 1,1,3-tris(2-methyl-4-hydroxy-5-tert-butyl)-butane, tetrakis [methylene(3,5-di-tert-butyl-4-hydroxycinnimate)]methane, dilauryl thiodipropionate, and distearyl thiodipropionate.

In an embodiment, the total amount antioxidant is present in an amount from about 0.01 wt. %, or from about 0.05 wt. %, or from about 0.1 wt. % or from about 0.2 wt. %, or from about 0.3 wt. %, or from about 0.4 wt. %, or from about 0.5 wt. %, or from about 0.6 wt. %, or from about 0.7 wt. %, or from about 0.8 wt. %, or from about 0.9 wt. %, or from about 1.0 wt. %, or to about 2 wt. %, or to about 1.9 wt. %, or to about 1.8 wt. %, or to about 1.7 wt. %, or to about 1.6 wt. %, or to about 1.5 wt. %, or to about 1.4 wt. %, or to about 1.3 wt. %, or to about 1.2 wt. %, or to about 1.1 wt. %, wherein all weight percentages are percent by weight of the total composition. In an embodiment, the total amount antioxidant is present in an amount from about 0.9 wt. % to about 1.1 wt. % wherein all weight percentages are percent by weight of the total composition. In an embodiment, the total amount antioxidant is present in an amount from about 1.9 wt. % to about 2.1 wt. % wherein all weight percentages are percent by weight of the total composition. In an embodiment, the total amount antioxidant is present in an amount of about 1 wt. % based on the total weight of the total composition. In an embodiment, the total amount antioxidant is present in an amount of about 2 wt. % based on the total weight of the total composition.

Propellant. In certain embodiments, the composition includes a propellant, for example to provide a force to expel the formulation from the container. In certain embodiments, the propellant is selected from the group comprising methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. In certain embodiments, the propellant is selected from the group consisting of methane, ethane, propane, pentane, isobutene, n-butane, isobutane, dimethyl ether, 1,1-difluoroethane, 1,1,1,2-tetrafluoroethane, carbon dioxide, nitrogen, air, and any combinations thereof. In certain embodiments, the composition includes about 1% to about 5% by weight the propellant, based on the total weight of the composition. In certain embodiments, the composition includes about 1.5 wt. % to about 4.5 wt. % of the propellant, based on the total weight of the composition. In certain embodiments, the composition includes about 2 wt. % to about 4% of the propellant, based on the total weight of the composition. In certain embodiments, the composition includes about 2.5 wt. % to about 3.5 wt. % of the propellant, based on the total weight of the composition. In certain embodiments, the composition includes about 2.7 wt. % to about 3 wt. % of the propellant, based on the total weight of the composition. While specific values chosen for this embodiment are recited, it is to be understood that, within the scope of the disclosure, the concentration of propellant may vary to suit different applications. The concentration ranges of propellant will vary based on the additional components of the insecticidal composition, including, but not limited to, the botanical solvent, the active components and the antioxidant.

Another embodiment of the pest control composition disclosed herein includes a method of killing and/or repelling insects comprising applying to a surface in need thereof a composition comprising at least one of prallethrin, metofluthrin, meperfluthrin, transfluthrin, pyrethrin extract, and PMD/Citriodiol® up to about 15 wt. %, and at least one botanical solvent up to about 99 wt. %, where the weight percentages are based on the total weight of the composition. In some embodiments, the botanical solvent can include ISANE® 58 or ISANE® 78. In some embodiments, the botanical solvent can include a mixture of ISANE® 58 and ISANE® 78. Particular embodiments can include up to about 2 wt. % of an antioxidant, based on the total weight of the composition.

Fragrance. In certain embodiments, the composition includes a fragrance, for example to provide a pleasing experience for the user. In certain embodiments, the fragrance is selected from the group comprising commercially available fragrances, natural fragrances, synthetic fragrances, and any combinations thereof. In certain embodiments, the composition includes about 0.01 wt. % to 8 wt. %, or about 0.1 wt. % to about 6 wt. %, or about 0.5 wt. % to about 6 wt. %, or about 0.6 wt. % to about 6 wt. %, or about 0.6 wt. %, or about 6 wt. % of a fragrance.

Any of the embodiments described herein may be modified to include any of the structures, compositions, or methodologies disclosed in connection with different embodiments. For example, some of the embodiments of the pest control composition disclosed herein may be used in conjunction with a liquid electric (LE) battery powered and/or liquid electric plug-in device that evaporates the volatile components of the composition. Some LE devices include a heating element for heating the pest control composition to promote its vaporization. Other LE devices employ a fan or blower to generate air flow to direct the pest control composition out of the LE device into the surrounding environment. Still other LE devices dispense the pest control composition using ultrasonic frequencies, for example, generated by a piezoelectric element, to dispense the pest control composition. Examples of this type of device and related devices can be found in U.S. application Ser. No. 17/878,629 and U.S. Pat. Nos. 11,384,312; 7,455,245; 6,361,752; 5,647,053; 5,290,546; 5,222,186; 5,095,647; 5,038,394; and 4,663,315, all of which are incorporated in their entirety by reference herein. Further, the compositions of the present disclosure may passively emanate and may evaporate into ambient environment through passive emanation.

In particular embodiments, the composition may also be used in combination with a heating device or apparatus that includes a heating element adjacent to a first end of a wick and a reservoir enclosing a second end of the wick, in which the composition may be contained. In this embodiment, the composition may be in contact with the second end of the wick, and upon application of an electric current to the heating element, the composition may be vaporized from the wick. For example, the compositions of the present disclosure may be used in combination with the volatile material dispenser disclosed in U.S. application Ser. No. 17/878,629, the entire contents of which is incorporated by reference herein.

The disclosure of the aforementioned patent applications, patents, and all other publications referred to herein are incorporated herein by reference as if fully set forth.

### Examples

The following Examples are provided to demonstrate and further illustrate certain embodiments and aspects of the present disclosure and are not to be construed as limiting the scope of the disclosure.

### Example 1

As shown in Tables 2-4, embodiments of the pest control composition can include at least one botanical solvent, at least one pesticide or pest control active component, and optionally an antioxidant. The total botanical solvent can be between about 40 wt. % to about 99 wt % of the total composition. The total active component can be between about 0.01 wt. % to about 15 wt. %. The antioxidant can be between about 0 wt. % to about 2 wt. %

TABLE 2
Categories of ingredients for pest control composition
and weight percentage ranges.

| Weight | Common | | | |
|---|---|---|---|---|
| Percent | Name | Chemical Name | Class | Function |
| 0.01- | Biomass- | Renewable | Alkanes | Solvent |
| 99% | based | hydrocarbons, | | |
| | solvent | C15-C18, | | |
| | | branched alkanes | | |
| 0.01%- | Active | Prallethrin, | Pyrethroids; | Active |
| 20% | | Metofluthrin, | Pyrethrin; | |
| | | Meperfluthrin, | Natural pyrethrin | |
| | | Transfluthrin, | | |
| | | Dimefluthrin, | | |
| | | Pyrethrin extract, | | |
| | | PMD/Citrefine | | |
| | | Citriodiol ® | | |
| 0-2% | BHT | Butylated | Antioxidant | Antioxidant |
| | | hydroxytoluene | | |
| 0.1-8% | Fragrance | various | Fragrance | Fragrance |

TABLE 3
Weight percentages for three example compositions I, II, and III.

| Compound | | I | II | III |
|---|---|---|---|---|
| (source purity) | Role | (wt. %) | (wt. %) | (wt. %) |
| prallethrin (92%) | Active | 1.30 | | |
| meperfluthrin (90% min) | Active | | 0.89 | |
| metofluthrin (94.1% min) | Active | | | 0.43 |
| ISANE ® BIOLIFE 58 | Botanical solvent | 83.70 | 68.11 | 68.58 |
| ISANE ® BIOLIFE 78 | Botanical solvent | 15 | 30 | 30 |
| BHT | Antioxidant | | 1 | 1 |
| Total | | 100 | 100 | 100 |

TABLE 4
Weight percentages for four
example compositions IV, V, VI, and VII.

| Compound | | IV | V | VI | VII |
|---|---|---|---|---|---|
| (source purity) | Role | (wt. %) | (wt. %) | (wt. %) | (wt. %) |
| Transfluthrin | Active | 0.89 | | | |
| (98.5% min) | | | | | |
| dimefluthrin (95%) | Active | | 0.65 | 0.32 | |
| Citriodiol | Active | | | | 12 |
| PYRETHRIN | Active | | | | 0.8 |
| EXTRACT | | | | | |
| (50%) | | | | | |
| ISANE ® BIOLIFE 58 | Botanical | 88.11 | | 98.08 | 67.2 |
| | solvent | | | | |
| ISANE ® BIOLIFE 78 | Botanical | 10 | 92.35 | | 20 |
| | solvent | | | | |
| BHT | Antioxidant | | 1 | 1 | |
| Essential oil of | Fragrance | 1 | | | |
| citronellol | | | | | |
| TAKASAGO RP-1538 | Fragrance | | | 0.6 | |
| Givaudan | Fragrance | | 6 | | |
| UT262637_00 | | | | | |
| W/IPM-Eucalyptus | | | | | |
| Total | | 100 | 100 | 100 | 100 |

Example composition I, as shown in Table 3, includes 1.30 wt. % of prallethrin (92%), 83.70 wt. % of ISANE® BIOLIFE 58, and 15 wt. % of ISANE® BIOLIFE 78.

Example composition II, as shown in Table 3, includes 0.89 wt. % of meperfluthrin (90%), ISANE® 68.11 wt. % of BIOLIFE 58, 30 wt. % of ISANE® BIOLIFE 78, and 1 wt. % BHT.

Example composition III, as shown in Table 3, includes 0.43 wt. % of metofluthrin (94.1%), 68.58 wt. % of ISANE® BIOLIFE 58, and 30 wt. % of ISANE® BIOLIFE 78, and 1 wt. % BHT.

Example composition IV, as shown in Table 4, includes 0.89 wt. % of Transfluthrin (98.5%), 88.11 wt. % of ISANE® BIOLIFE 58, and 10 wt. % of ISANE® BIOLIFE 78, and 1 wt. % of a fragrance.

Example composition V, as shown in Table 4, includes 0.65 wt. % of dimefluthrin (95%), 92.35 wt. % of ISANE® BIOLIFE 78, 1 wt. % of BHT, and 6 wt. % of a fragrance.

Example composition VI, as shown in Table 4, includes 0.32 wt. % of dimefluthrin (95%), 98.08 wt. % of ISANE® BIOLIFE 58, 1 wt. % of BHT, and 0.6 wt. % of a fragrance.

Example composition VII, as shown in Table 4, includes 12 wt. % of Citriodiol, 0.8 wt. % of pyrethrin extract (50%), 67.2 wt. % of ISANE® BIOLIFE 58, and 20 wt. % of ISANE® BIOLIFE 78.

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the at least two active ingredients selected for the pest control composition, the target pest, and the amounts of the various ingredients present in the pest control composition. Various embodiments of the invention can specifically include or exclude any of these variations or elements.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A composition for pest control, the composition comprising:
at least one active component selected from the group consisting essentially of prallethrin, meperfluthrin, metofluthrin, transfluthrin, dimefluthrin, natural pyrethrin extract, p-menthane-3,8-diol, and combinations thereof,
at least one botanical solvent; and
an antioxidant;
wherein the botanical solvent comprises at least one renewable hydrocarbon.

2. The composition of claim 1, wherein the composition comprises:
between about 0.01 wt. % and about 20 wt. % of the at least one active component selected from the group consisting essentially of prallethrin, meperfluthrin, metofluthrin, transfluthrin, dimefluthrin, natural pyrethrin extract, p-menthane-3,8-diol, and combinations thereof, and
wherein the botanical solvent comprises at least one C₁₅-C₁₈ branched alkane;
wherein all weight percentages are percent by weight of the total composition.

3. The composition of claim 2, wherein the composition comprises:
between about 0.1 wt. % and about 2.0 wt. % of at least one active component; and
between about 1 wt. % and about 99 wt. % of the botanical solvent; wherein all weight percentages are percent by weight of the total composition.

4. The composition of claim 3, comprising between about 0.01 wt. % and about 2 wt. % of the antioxidant, wherein all weight percentages are percent by weight of the total composition.

5. The composition of claim 1, wherein the composition comprises:
between about 0.01 wt. % and about 20 wt. % of the at least one active component selected from the group consisting essentially of prallethrin, meperfluthrin, metofluthrin, transfluthrin, dimefluthrin, natural pyrethrin extract, p-menthane-3,8-diol, and combinations thereof, and
between about 0.1 wt. % to about 99 wt. % of a first botanical solvent; and
between about 0.1 wt. % to about 99 wt. % of a second botanical solvent;
wherein all weight percentages are percent by weight of the total composition.

6. The composition of claim 5, wherein the first botanical solvent comprises a C₁₅-C₁₈ branched alkane and the second botanical solvent comprises a C₁₇-C₁₈ branched alkane;
wherein each of the first and second botanical solvents contain less than about 0.005 wt. % aromatic hydrocarbon.

7. The composition of claim 6, wherein the composition comprises greater than 90 wt. % of one of the first botanical solvent or the second botanical solvent, wherein all weight percentages are percent by weight of the total composition.

8. The composition of claim 6, wherein the active component is present at between about 0.1 wt. % to about 2.0 wt. %, wherein all weight percentages are percent by weight of the total composition.

9. The composition of claim 8, further comprising between about 0.01 wt. % to about 2 wt. % of the antioxidant, wherein all weight percentages are percent by weight of the total composition.

10. The composition of claim 9, wherein the antioxidant is selected from the group consisting essentially of 2,6-di-tert-butyl-4-methylphenol (BHT), 3-tert-butyl-4-hydroxyanisole (BHA), 2,2′-methylene-bis(4-ethyl-6-tert-butylphenol), 2,2′-methylene-bis-(4-methyl-6-tert-butylphenol), 4,4′-butylidene-bis(5-methyl-6-tert-butylphenol), 4,4′-methylene-bis(2-methyl-6-tert-butylphenol), 4,4′-thio-bis(3-methyl-6-tert-butylphenol), 4,4′-methylene-bis(2,6-di-tertbutylphenol), stearyl-P(3,5-di-tert-butyl-4-hydroxyphenol)-propionate, 1,3,5-trimethyl-2,4-6-tris(3,5-di-tert-butyl-4-hydroxybenzylbenzene), 1,1,3-tris(2-methyl-4-hydroxy-5-tert-butyl)-butane, tetrakis [methylene(3,5-di-tert-butyl-4-hydroxycinnimate)]methane, dilauryl thiodipropionate, distearyl thiodipropionate, and any combinations thereof.

11. The composition of claim 10, wherein the composition further comprises a fragrance.

12. The composition of claim 11 wherein the fragrance is present in about 0.01 wt. % to about 8 wt. %, wherein all weight percentages are percent by weight of the total composition.

13. The composition of claim 11, further comprising a propellant, wherein the propellant is selected from the group consisting essentially of compressed gas propellants, liquified gas propellants, saturated hydrocarbons, mixtures of liquified and compressed gas, methane, ethane, propane, n-butane, isobutane, isobutene, pentane, isopentane, dimethyl ether, 1,1-difluoroethane, 1,1,1,2-tetrafluoroethane, carbon dioxide, nitrogen, air, and any combinations thereof.

14. The composition of claim 1, wherein the botanical solvent is at least about 95 wt. % renewable hydrocarbon, wherein all weight percentages are percent by weight of the total composition.

15. An apparatus for pest control, the apparatus comprising:
an electric device that comprises a wick having a first end and a second end;
and a composition in contact with the second end of the wick, wherein the composition comprises at least one active component, at least one botanical solvent with at least one renewable hydrocarbon, and an antioxidant.

16. The apparatus of claim 15, wherein the composition comprises:
between about 0.01 wt. % to about 20 wt. % of the at least one active component selected from the group consisting essentially of prallethrin, meperfluthrin, metofluthrin, transfluthrin, dimefluthrin, pyrethrin extract, p-menthane-3,8-diol, and combinations thereof, and
between about 40 wt. % to about 99 wt. % of the botanical solvent;
wherein all weight percentages are percent by weight of the total composition.

17. The apparatus of claim 15, wherein the composition comprises:
between about 0.1 wt. % to about 2.0 wt. % of the at least one active component selected from the group consisting essentially of prallethrin, meperfluthrin, metofluthrin, transfluthrin, dimefluthrin, pyrethrin extract, p-menthane-3,8-diol, and combinations thereof,
between about 1.0 wt. % to about 99 wt. % of a first botanical solvent; and
about 1.0 wt. % to about 99 wt. % of a second botanical solvent;
wherein the first botanical solvent and the second botanical solvent comprise renewable hydrocarbons; and
wherein all weight percentages are percent by weight of the total composition.

18. The apparatus of claim 17, wherein the composition comprises greater than 90 wt. % of one of the first botanical solvent or the second botanical solvent.

19. The apparatus of claim 15, wherein the composition further comprises a fragrance.

20. The apparatus of claim 19, wherein the fragrance is present in about 0.01 wt. % to about 8 wt. %, wherein all weight percentages are percent by weight of the total composition.
